(19) United States
(12) Patent Application Publication
(10) Pub. No.: US 2007/0033020 A1
(43) Pub. Date: Feb. 8, 2007

(54) Estimation of noise in a speech signal

(76) Inventors: Holly L. (Kelleher) Francois, Guildford (GB); David J. Pearce, Basingstoke (GB)

Correspondence Address: MOTOROLA, INC., 1303 EAST ALGONQUIN ROAD, IL01/3RD, SCHAUMBURG, IL, 60196, US

(21) Appl. No.: 10/547,161

(22) PCT Filed: Jan. 23, 2004
(86) PCT No.: PCT/EP04/50038

§ 371 Date: Oct. 17, 2006

(30) Foreign Application Priority Data
Feb. 27, 2003 (GB) 0304481.5

(51) Int. Cl. G10L 21/02

(52) U.S. Cl. 704/226

(57) ABSTRACT

A speech communication or computing device comprises at least one speech input device for receiving noisy speech uttered by a speaker. A speech processing function comprises a voice recognition function, which comprises a noise reduction function (235) having a Wiener Filter (335) with adjustable filter co-efficients. The speech input device also comprises multiple microphones (142, 144) configured to provide a substantially continuous noise signal to a noise spectrum estimation function (325) of the noise reduction function (235) to provide a substantially continuous estimate of noise. The noise estimate is used to adjust the filter co-efficients of the Wiener Filter (335), thereby removing noise from the noisy speech. A microphone array and a method for speech recognition are also described. By using the noise estimate from, say, a microphone array, the Wiener filter coefficients can be updated substantially continuously, for example, each speech frame. This enables the noise to be tracked more closely than in known techniques. As the noise within a speech signal is tracked more closely, it can therefore be removed more effectively.

### FIELD OF THE INVENTION

This invention relates to noise estimation in speech recognition using multiple microphones. The invention is applicable to, but not limited to, a microphone array for estimating noise in a speech recognition unit to assist in noise suppression.

### BACKGROUND OF THE INVENTION

In the field of speech communication, it is known that voiced speech sounds (e.g. vowels) are generated by the vocal chords. In the spectral domain the regular pulses of this excitation appear as regularly spaced harmonics. The amplitudes of these harmonics are determined by the vocal tract response and depend on the mouth shape used to create the sound. The resulting sets of resonant frequencies are known as formants.

Speech is made up of utterances with gaps therebetween. The gaps between utterances would be close to silent in a quiet environment, but contain noise when spoken in a noisy environment. The noise results in structures in the spectrum that often cause errors in speech processing applications, such as automatic speech recognition, front-end processing in distributed automatic speech recognition, speech enhancement, echo cancellation, and speech coding. For example, in the case of speech recognisers, insertion errors may be caused. The speech recognition system may try to interpret any structure it encounters as being one of the range of words it has been trained to recognise. This results in the insertion of false-positive word identifications.

Clearly, this compromises performance. In context-free speech scenarios (such as voice dialling or credit card transactions), spurious word insertions are not only impossible to detect, but invalidate the whole utterance in which they occur. It would therefore be desirable to have the capability to screen out such spurious structures from the start.

Within utterances, noise serves to distort the speech structure, either by addition to or subtraction from the ‘original’ speech. Such distortions can result in substitution errors, where one word is mistaken for another. Again, this clearly compromises performance.

In conventional systems, a noise estimate is usually obtained only during the gaps between utterances and is assumed to remain the same during an utterance until the next gap, when the noise estimate can be updated.

Many speech enhancement/noise mitigation methods assume full knowledge of the short-term noise spectrum. This assumption holds true in the case of ‘stationary noise’. That is, noise whose spectral characteristics do not change over the duration of the utterance. An example would be a car driving at steady speed on a uniform road surface.

However, in many real-world environments the noise is non-stationary. Examples include a busy street with vehicles passing, or on a train, where the rail tracks form a staccato accompaniment to the speech.

Thus, it is known that noise reduction of a noisy speech signal is a pre-requisite of current speech communication, for example in the area of wireless speech communication or for improved speech recognition.

The focus of the European Telecommunication Standard Institute's (ETSI) Advanced distributed speech recognition (DSR) front-end Standard's body is to provide superior speech recognition performance for speech or multimodal user interfaces. It can also be used to improve performance in noisy car environments for, say, telematics applications.

In the field of microphones, it is known that null beamforming microphone arrays have been used to form noise estimates for direct spectral subtraction as described in [1], [2] and [3]. In these papers an array formed from two or more microphones is used to place a null on the speaker. In this context, a null is a point, or a direction, in space where the microphone array has a zero response, i.e. sounds orginating from this position will be severely attenuated in the array output.

In this manner, when a null is positioned on the talker, the output of the array provides a good estimate of the ambient noise. A second, noisy speech signal is also obtained from one or more of the microphones used by the user. Both signals are then transformed into the frequency domain, where non-linear spectral subtraction is applied, to remove the noise from the speech.

In ‘Speech enhancement and source separation based on binaural negative beamforming’, authored by Alvarez, A.; Gomez, P.; Martinez, R.; Nieto, V.; Rodellar, V. Eurospeech 2001, September 2001, Aalborg, Denmark, pages: 2615 to 2619c, the authors propose using a two microphone negative beamformer to steer a null onto the speaker in order to estimate the noise. Spectral subtraction is then used to remove the noise from a reference signal that contains both the speech and the noise. The array is of a compact size, since the two microphones are spaced only 5 cm apart. The null is steered onto the speaker, by assuming that the source location is the point for which the output power of the negative beamformer is minimised. The technique has only been tried in a rather artificial experiment, and has notably only been applied in the context of ‘speech enhancement’.

A 20 cm array of three microphones has been used to obtain a noise estimate, as described in ‘Noise reduction by paired-microphones using spectral subtraction’, authored by Mizumachi, M. and Akagi, M. and published in the Proceedings of the 1998 IEEE International Conference on ‘Acoustics, Speech and Signal Processing, Volume 2, Page(s): 1001-1004 [2]. In this paper, the centre and left microphones, the centre and right microphones and the left and right microphones effectively form three sub-arrays. These sub-arrays are used to estimate the noise direction. The array nulls are then steered on to the speaker in order to obtain a noise estimate. This noise estimate is then subtracted from the noisy speech obtained from the central microphone using non-linear spectral subtraction.

The technique is similar to that described in Alvarez et al 2001. However, the method of estimating the noise direction differs. In Mizumachi and Akagi's paper, results are provided in terms of noise reduction, with a signal-to-noise (SNR) improvement of up to 6 dB being obtained. However, their approach appears to suffer from problems with the estimation of the noise direction in ‘real-world’ testing.

In the paper titled ‘Adaptive parameter compensation for robust hands-free speech recognition using a dual beamforming microphone array’, authored by McCowan, I. A. and Sridharan, S. and published in the Proceedings of 2001 International Symposium on ‘Intelligent Multimedia, Video and Speech Processing’ pages: 547-550, [3], McCowan and Sridharan propose a dual beamformer to be used to separately estimate both the speech signal and noise signal. A broadband sub-array delay sum beamformer is used to obtain the speech signal in their experiments. Furthermore, a signal-cancelling spatial notch filter is used to obtain the noise estimate. These beamformers are implemented using an array of nine microphones in a non-linearly spaced 40 cm broadside array.

Non-linear spectral subtraction is then applied in the Mel domain to obtain noise robust Mel Frequency Cepstral Coefficients (MFCC's). As known to those skilled in the art, this is a common (Mel) frequency warping technique that is applied to the spectral domain to convert signals into the Mel domain. Significant improvements in speech recognition rate were reported for both localised and ambient noise sources. For example, 70-85% reduction in word error rate (WER) when compared to MFCC for a localised and ambient SNR of 0-10 dB. Notably, in this context, no beam-steering is employed; it is assumed that the speaker is directly in front of the array.

Thus, [1] and [2] describe microphone array arrangements, coupled to spectral subtraction techniques, used solely in the area of ‘speech enhancement’.

A known ‘alternative’ technique to spectral subtraction is to use Wiener Filters, in noise reduction. U.S. Pat. No. 5,706,395 (Arslan) [4] describes such a method, using preceding frame noise as an estimate of current frame noise. In the paper ‘Analysis of noise reduction and de-reverberation techniques based on microphone arrays with post-filtering’, authored by Marro, C.; Mahieux, Y.; Simmer, K. U. and published in IEEE Transactions on ‘Speech and Audio Processing’, Volume: 6, Issue: 3, May 1998 pages: 240-259 [5], Marro, Mahieux and Simmer propose a ‘speech enhancement’ technique based on the use of a microphone array combined with a Wiener post-filter. In [5], both beamforming and directivity controlled arrays are examined, with the Wiener filter estimation being based on the spectrums from both array microphones. Of note in [5] was the fact that the post-filter only provided an improvement when the array was effective, i.e. if the noise reduction factor of the array was ‘1’ (e.g. at low frequencies), then the Wiener filter transfer function was also ‘1’. Also of note is the fact that the Wiener filter also provided no advantage if there was noise within the beam of the array or within a grating lobe.

The approach of using a microphone array combined with a Wiener post-filter was applied to speech recognition with promising results, as described in the paper titled ‘Robust speech recognition using near-field superdirective beamforming with post-filtering’, authored by McCowan, I. A.; Marro, C.; Mauuary, L. and published in the IEEE International Conference on ‘Acoustics, Speech, and Signal Processing,’ ICASSP Proceedings 2000, Volume: 3, pages: 1723-1726 [6]. Here, the WER on the well-known TIDIGITS database was reduced from 41% to 9%, when ambient noise at an SNR of 10 dB and a secondary talker in a fixed position were added.

In another separate technique, sub-band Wiener filters have been used in conjunction with beam forming microphone arrays to produce an additional gain in SNR, as illustrated in [5] and [6]. In this case the Wiener filter coefficients are calculated using the coherence between the microphones. However, this is only effective if the noise is spatially diffuse, which is not always the case.

In order to calculate the coefficients of the Wiener filter an estimate of the noise is required. These estimates are taken during the gaps between the speech segments.

The inventors have recognized and appreciated some limitations of this approach. In summary, such an approach concentrates on stationary noise. Hence, all of these techniques obtain the noise estimate just before the start of the speech, and then update the estimate in the speech-gaps, which is not ideal.

Thus, improving a noisy speech signal by more accurately estimating and removing background noise is a fundamental step in noise robust speech processing. Wiener filtering is an effective technique for the removal of background noise, and is the technique used in the ETSI Standard Advanced Front End for DSR. However, by specifying the use of a Wiener filtering approach, the aforementioned Spectral subtraction techniques are effectively precluded from use. Spectral subtraction and Wiener filtering are two different techniques that are independently used for noise robust speech recognition. They both essentially reduce the noise, but use different approaches. Thus, the two techniques cannot be used at the same time. In practice, this means that it is impossible to perform spectral subtraction using multiple microphones in conjunction with the Advanced Front End.

A need therefore exists for an improved microphone array arrangement wherein the abovementioned disadvantages may be alleviated.

### STATEMENT OF INVENTION

The present invention provides a communication or computing device, as claimed in claim 1, a method for speech recognition in a speech communication or computing device, as claimed in claim 9, and a storage medium, as claimed in claim 10. Further features are as claimed in the dependent Claims.

In summary, the present invention proposes to use a null beamforming microphone array to provide a substantially continuous noise estimate. This substantially continuous (and therefore more accurate) noise estimate is then used to adjust the coefficients of a Wiener Filter. In this manner, a noise estimation technique that uses spectral subtraction can be applied to a Wiener Filter approach, for example, the Double Wiener Filter proposed by the ETSI DSR Advanced Front End. Advantageously, the proposed technique can be applied in any microphone array scenario where non-spatially diffuse noises exist.

### BRIEF DESCRIPTION OF THE DRAWINGS

Embodiments of the present invention will now be described, by way of example only, with reference to the accompanying drawings, in which:

FIG. 1 illustrates a block diagram example of a speech communication unit employing speech recognition that has been adapted in accordance with a preferred embodiment of the present invention;

FIG. 2 illustrates a speech recognition function block diagram of the speech communication unit of FIG. 1 that has been adapted in accordance with a preferred embodiment of the present invention;

FIG. 3 illustrates a noise reduction block diagram used in the speech recognition function of FIG. 2, and adapted in accordance with a preferred embodiment of the present invention;

FIG. 4 illustrates a polar plot of a microphone array configured to provide an input signal to the speech recognition function of FIG. 2, in accordance with a preferred embodiment of the present invention;

FIG. 5 illustrates a Wiener Filter block diagram used in the noise reduction block of FIG. 3, and adapted in accordance with a preferred embodiment of the present invention; and

FIG. 6 is a flowchart illustrating a process of speech recognition using a Wiener Filter in accordance with a preferred embodiment of the present invention.

### DESCRIPTION OF PREFERRED EMBODIMENTS

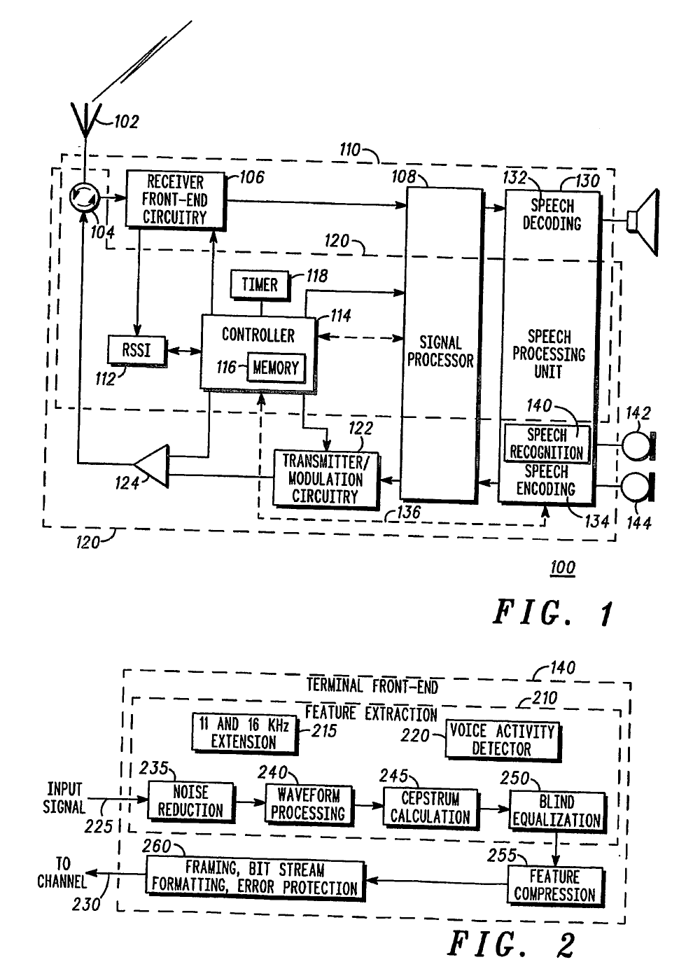

Referring now to FIG. 1, there is shown a block diagram of a wireless subscriber speech communication unit, adapted to support the inventive concepts of the preferred embodiments of the present invention. Although the present invention is described with reference to speech recognition in a wireless communication unit such as a third generation cellular device, it is within the contemplation of the invention that the inventive concepts can be equally applied to any speech-based device.

As known in the art, the speech communication unit 100 contains an antenna 102 preferably coupled to a duplex filter or antenna switch 104 that provides isolation between a receiver chain and a transmitter chain within the speech communication unit 100. As also known in the art, the receiver chain typically includes receiver front-end circuitry 106 (effectively providing reception, filtering and intermediate or base-band frequency conversion). The front-end circuit is serially coupled to a signal processing function 108. An output from the signal processing function is provided to a suitable output device 110, such as a speaker via a speech-processing unit 130.

The speech-processing unit 130 includes a speech encoding function 134 to encode a user's speech signals into a format suitable for transmitting over the transmission medium. The speech-processing unit 130 also includes a speech decoding function 132 to decode received speech signals into a format suitable for outputting via the output device (speaker) 110. The speech-processing unit 130 is operably coupled to a memory unit 116, via link 136, and a timer 118 via a controller 114.

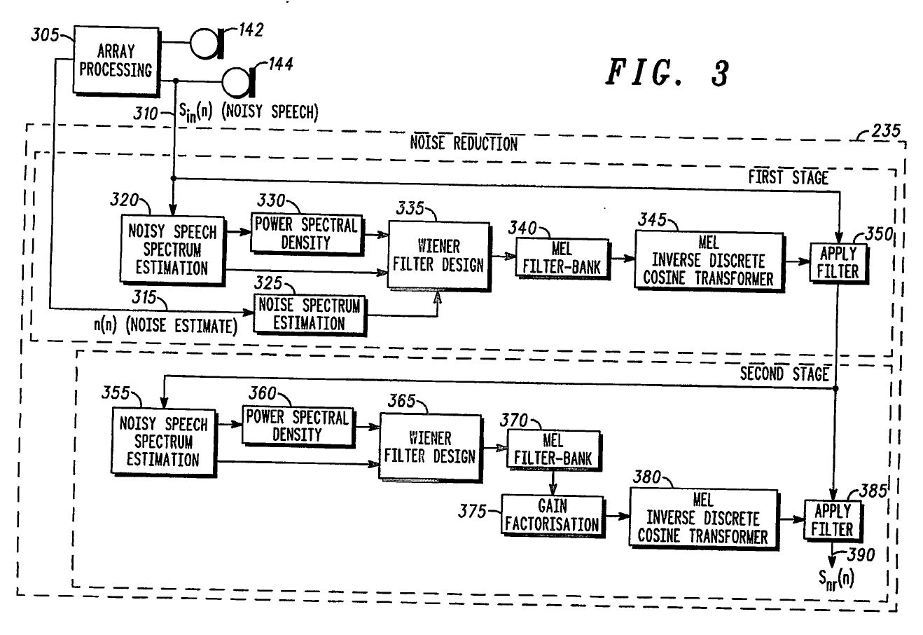

In particular, the operation of the speech-processing unit 130 has been adapted to support the inventive concepts of the preferred embodiments of the present invention. The adaptation of the speech-processing unit 130 is further described with regard to FIG. 2 and FIG. 3.

For completeness, the receiver chain also includes received signal strength indicator (RSSI) circuitry 112 (shown coupled to the receiver front-end 106, although the RSSI circuitry 112 could be located elsewhere within the receiver chain). The RSSI circuitry is coupled to a controller 114 for maintaining overall subscriber unit control. The controller 114 is also coupled to the receiver front-end circuitry 106 and the signal processing function 108 (generally realised by a DSP).

The controller 114 may therefore receive bit error rate (BER) or frame error rate (FER) data from recovered information. The controller 114 is coupled to the memory device 116 for storing operating regimes, such as decoding/encoding functions and the like. A timer 118 is typically coupled to the controller 114 to control the timing of operations (transmission or reception of time-dependent signals) within the speech communication unit 100.

In the context of the present invention, the timer 118 dictates the timing of speech signals, in the transmit (encoding) path and/or the receive (decoding) path.

As regards the transmit chain, this essentially includes an input device 120, such as a microphone transducer coupled in series via speech encoder 134 to a transmitter/modulation circuit 122. Thereafter, any transmit signal is passed through a power amplifier 124 to be radiated from the antenna 102. The transmitter/modulation circuitry 122 and the power amplifier 124 are operationally responsive to the controller, with an output from the power amplifier coupled to the duplex filter or circulator 104. The transmitter/modulation circuitry 122 and receiver front-end circuitry 106 comprise frequency up-conversion and frequency down-conversion functions (not shown).

Of course, the various components within the speech communication unit 100 can be arranged in any suitable functional topology able to utilise the inventive concepts of the present invention. Furthermore, the various components within the speech communication unit 100 can be realised in discrete or integrated component form, with an ultimate structure therefore being merely an application-specific selection.

It is within the contemplation of the present invention that the preferred use of speech processing and speech storing can be implemented in software, firmware or hardware, with the function being implemented in a software processor (or indeed a digital signal processor (DSP)), performing the speech processing function, merely a preferred option.

More generally, it is envisaged that any re-programming or adaptation of the speech processing function 130, according to the preferred embodiment of the present invention, may be implemented in any suitable manner. For example, a new speech processor or memory device 116 may be added to a conventional wireless communication unit 100. Alternatively, existing parts of a conventional wireless communication unit may be adapted, for example, by reprogramming one or more processors therein. As such the required adaptation may be implemented in the form of processor-implementable instructions stored on a storage medium, such as a floppy disk, hard disk, programmable read-only memory (PROM), random access memory (RAM) or any combination of these or other storage media.

Referring now to FIG. 2, the speech recognition function 140 of the speech communication unit of FIG. 1 is illustrated in greater detail. The speech recognition function 140 has been adapted in accordance with a preferred embodiment of the present invention. A speech signal 225 is input to a feature extraction function 210 of the speech processing unit, in order to extract the speech characteristics to perform speech recognition. The feature extraction function 210 preferably includes a speech frequency extension block 215, to provide a wider audio frequency range of signal processing to facilitate better quality speech recognition. The feature extraction function 210 also preferably includes a voice activity detector function 220, as known in the art.

The input speech signal 225 is input to a noise reduction function 235, which has been adapted in accordance with the preferred embodiment of the present invention, as described below with respect to FIG. 3 and FIG. 5. As known in the art, for example in accordance with the ETSI Advanced Front-end DSR configuration, the ‘cleaned-up’ speech signal output from the noise reduction function 235 is input to a waveform processing unit 240, where the high signal to noise ratio (SNR) portions of the speech waveform are emphasized, and the low SNR waveform portions are de-emphasized by a weighting function. In this way, the overall SNR is improved and also the speech periodicity is enhanced.

The output from the waveform processing unit 240 is input to a Cepstrum calculation block 245, which calculates the log, Mel-scale, cepstral features (MFCC's). The output from the Cepstrum calculation block 245 is input to a blind equalization function 250, which minimizes the mean square error computed as a difference between the current and target cepstrum. This reduces the convolutional distortion caused by the use of different microphones in training of accoustic models and testing. In this manner, the desired speech characteristics/features are extracted from the speech signal to facilitate speech recognition.

The output from the blind equalization function 250, of the feature extraction function 210, is input to a feature compression function 255, which performs split vector quantisation on the speech features. The output from the feature compression function 255 is processed by function 260, which frames, formats and incorporates error protection into the speech bit stream 260. The speech signal is then ready for converting, as described above with respect to FIG. 1, for transmission over the communication channel 230.

Referring now to FIG. 3, the noise reduction block 235 in the speech recognition function of FIG. 2 is illustrated and described in greater detail. The noise reduction block 235 has been adapted in accordance with a preferred embodiment of the present invention.

The preferred embodiment of the present invention utilises the known technique of configuring a microphone array 142, 144 in such a way as to place a ‘null’ on the talker. A simple example of this ‘nulling’ feature is illustrated in FIG. 4, which shows a polar plot 400 of a cardioid microphone with a null at 405.

As illustrated in FIG. 4, the cardioid microphone has directional sensitivity, and hence responds strongly to sounds from one direction, whilst having a null in the opposite direction. If this null is orientated towards the speaker, the output of the microphone will be the background noise. The plot illustrated in FIG. 4 is just a simple example; a sharper null can be constructed by using a more complex array design, for example by subtracting the outputs of two cardioid microphones 142 and 144 in the array processing module 305 to produce the noise estimate 315.

A second signal is obtained: either from a single microphone 144 or a second microphone array (not illustrated). In both cases the null is orientated directly away from the speaker, so that the output of the microphone (or array) (Sᵢₙ(n)) 310 contains both speech and noise. The Wiener filter is then applied to this second signal in order to ‘clean up’ the noisy speech.

In accordance with the preferred embodiment, the output from the two microphones 142, 144 is input to an array processing function 305 (in FIG. 3). The array processing function subtracts the outputs of two cardioid microphones 142 and 144 to produce a noise estimate signal n(n) 315.

In accordance with the preferred embodiment of the present invention, these two signals: the noisy speech and signal (Sᵢₙ(n)) 310 and the noise estimate signal n(n) 315 are then used in the calculation of the optimal Wiener filter coefficients within the noise reduction function 235 of the speech recognition block 140. The Wiener Filter 335, 365 is then iteratively optimized to remove the effects of this noise.

Referring back to FIG. 3, the noise estimate signal n(n) 315 is input to a first noise reduction stage. In particular, the noise estimate signal n(n) 315 is input to a noise spectrum estimation function 325 to provide an estimate of the spectral properties of the background noise related to the talker at a particular point in time. The output of the noise spectrum estimation function 325 is input to a first Wiener Filter design block 335, illustrated in greater detail in FIG. 5.

Concurrently, the speech and noise signal (Sᵢₙ(n)) 310 is input to a first noisy speech spectrum estimation function 320 to provide an estimate of the spectral properties of the combined background noise and speech related to the talker at a particular point in time. Two outputs of the noisy speech spectrum estimation function 320 are input to the first Wiener Filter design block 335: a first noisy speech spectral estimated signal output that is processed to determine a power spectral density 330 (PSD) mean value and, secondly, the noisy speech spectral estimated signal itself. As mentioned above, the adapted operation of the Wiener Filter design block 335 is described below with respect to FIG. 5.

The output from the first Wiener Filter design block 335 is input to a MEL filter bank 340, which smooths and transforms the Wiener filter frequency characteristic to a Mel-frequency scale by using, for example, twenty-three triangular Mel-warped frequency windows. The output from the MEL filter bank 340 is input to an inverse discrete cosine transform (IDCT) function 345 and these values used in Filter 350. This filter is then applied to the input noisy speech signal (Sᵢₙ(n)) 310, which is also routed to Filter 350. The filtering of the noisy speech signal substantially removes the noise characteristics, producing a cleaner speech signal.

The filtered noisy speech signal (Sᵢₙ(n)) is then optionally input to a second noise reduction stage. This two stage design is known as a Double Wiener Filter and is used in the ETS Advanced Front End. However, it is envisaged that a single Wiener filter could also be used. In particular, the filtered speech signal (having reduced noise) is input to a second noisy speech spectrum estimation function 355 to provide a further refined estimate of the spectral properties of the combined background noise and speech related to the talker at a particular point in time.

Again, two outputs of the noisy speech spectrum estimation function 355 are input to a second Wiener Filter design 365: a first noisy speech spectral estimated signal output that is processed to determine a power spectral density 360 (PSD) mean value and, secondly, the noisy speech spectral estimated signal itself.

The output from the second Wiener Filter design block 365 is input to a second MEL filter bank 370, which smooths and transforms the Wiener filter frequency characteristic to a Mel-frequency scale by using, for example, twenty-three triangular Mel-warped frequency windows. The output from the second MEL filter bank 370 is input to a gain factorization function 375. In this block, a dynamic, SNR-dependent noise reduction process is performed in such a way that more aggressive noise reduction is applied to purely noisy frames and less aggressive noise reduction is used in frames also containing speech. The output from the gain factorization function 375 is input to a second inverse discrete cosine transform function 380 and these values used in a second Filter 385.

As shown, the filtered input noisy speech signal is also routed to the second Filter 385, where the noisy speech signal is further filtered to remove (substantially) any remaining noise characteristics. A noise reduced speech signal (Sₙᵣ(n)) 390 is then used in the transmission of speech, as described above with respect to FIG. 2 and FIG. 1.

Referring now to FIG. 5, a Wiener Filter block diagram used in the noise reduction block 235 of FIG. 3 is illustrated. The function of the Wiener Filter 335 has been adapted in accordance with a preferred embodiment of the present invention. As described above, a noise estimate signal (n(n)) 315, which was obtained from the microphone array, is input to a noise spectrum estimation function 325 to provide a continuous estimate of the spectral properties of the background noise related to the talker at a particular point in time. Notably, this configuration contrasts known Wiener Filter arrangements whereby the power spectral density (PSD) mean value of the noisy speech signal, during gaps in the speech, is input to the noise estimation function.

The output (S_{N}) of the noise spectrum estimation function 325 is then input to a first de-noised spectrum estimation function 510, a first Wiener Filter gain calculation function 515 and a second Wiener Filter gain calculation function 525.

Concurrently, the speech and noise signal (Sᵢₙ(n)) is input to a third de-noised spectrum estimation function 535 to provide an estimate of the spectral properties of the combined background noise and noisy speech related to the talker at a particular point in time. Concurrently, a power spectral density (PSD) mean value of the noisy speech signal 515 is also input to the first de-noised spectrum estimation function 510 and the second de-noised spectrum estimation function 520.

This iterative process optimizes the Wiener Filter co-efficients such that when the output co-efficients 530 are used to filter the noisy speech signal 310, the resulting signal is substantially cleaner.

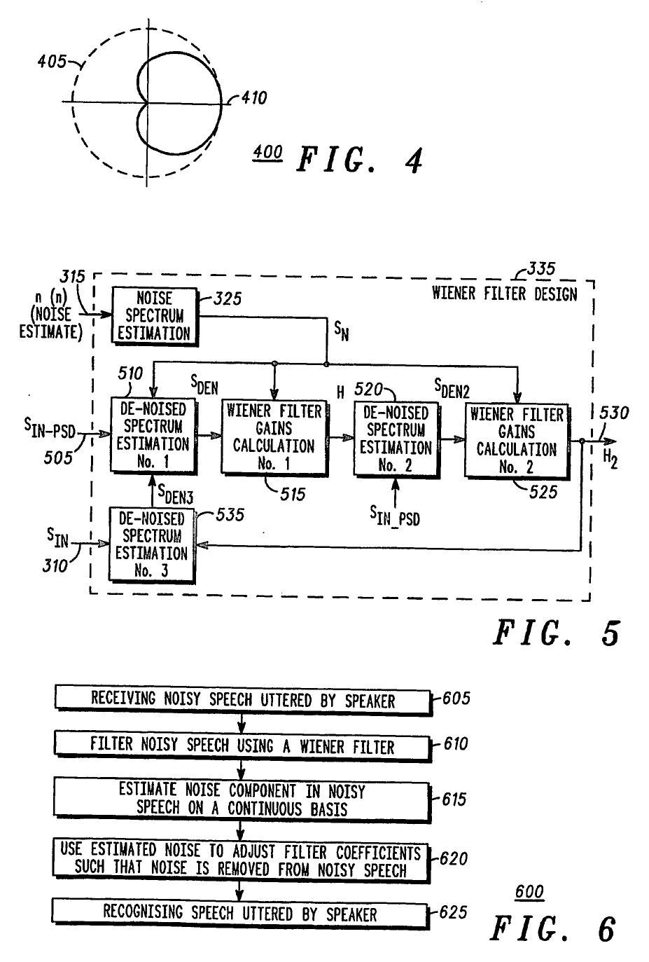

Referring now to FIG. 6, a flowchart 600 of the preferred process for speech recognition in a speech communication or computing device is illustrated. The process of speech recognition comprises the step of receiving noisy speech uttered by a speaker, as shown in step 605. The noisy speech is preferably filtered, in accordance with the above-described mechanism, using a Wiener Filter to remove noise from the noisy speech, as in step 610.

A noise component of the noisy speech uttered by the speaker is estimated in a substantially continuous manner using a microphone array, as shown in step 615. The estimated noise is then used in a substantially continuous manner to adjust filter co-efficients of the Wiener Filter, thereby removing noise from the noisy speech on a substantially continuous basis, as in step 620. In this manner, speech uttered by the speaker can then be recognised, irrespective (to some degree) of the level of background noise prevalent at the time of speaking, as in step 625.

Advantageously, the aforementioned noise reduction topology enables the speech recognition function of a speech communication unit to utilize the performance attributes of both spectral estimation as well as a Wiener Filter noise reduction technique. Furthermore, this topology can be applied directly to the double Wiener filtering stage of ETSI's DSR Advanced Front End, by substituting the current noise estimate for the improved noise estimate described above. In this manner, the improved design provides interoperability and backward compatibility with standard speech communication units.

In the known speech recognition techniques, such as ETSI's DSR Advanced Front End, the noise estimate used by a Wiener filter is obtained by using a Voice Activity Detector 220 to find the non-speech portions of the utterance. Hence, the noise estimate is only updated during the pauses between words. If the noise is non-stationary, as is often the case, the estimate may not track the actual noise closely enough, primarily due to the updates being inherently intermittent. This results in the filter coefficients being sub-optimal in the known speech recognition mechanisms.

However, in accordance with the preferred embodiment of the present invention, by using the noise estimate 315 from the microphone array 142 the filter coefficients are able to be updated each frame. This enables the noise to be tracked more closely. The improved noise estimate 315 is obtained from the ‘null’ forming microphone array 142 and the array processing function 305.

It is noteworthy that, in the art of microphone arrays, microphone arrays have been predominantly used in the area of positive beamforming to enhance the SNR. Alternatively, they have been used to place a null on (i.e. cancel) a known, fixed noise source. Furthermore, the technique also overcomes the restriction of the noise being spatially diffuse, which is a problem when a sub-band Wiener filtering technique is used, as described in [4] and [5].

In experimental tests, the inventors of the present invention have shown a reduction in the error rate of up to 44%, compared to the conventional way of obtaining the noise estimate, by applying the inventive concepts described herein.

The preferred embodiment of the present invention has been described for implementation in the ETSI Advanced DSR front-end speech recognition standard. However, it is within the contemplation of the present invention that the inventive concepts can be applied to speech recognition in any speech communication handset or accessory, for example in vehicle use, a computer responsive to speech input, etc.

It is also envisaged that the improved speech recognition technique can be utilised in home, for example, in a web-pad voice interface. As well as the DSR application scenario the technique can also be used in conjunction with local speech recognition mechanisms to improve the communication unit's performance. In this case there are alternatives to using the Wiener filtering technique described above.

Apparatus of the Invention:

A speech communication or computing device has been described that comprises at least one speech input device for receiving noisy speech uttered by a speaker. A speech processing function comprises a voice recognition function, which comprises a noise reduction function having a Wiener Filter with adjustable filter co-efficients. The speech input device also comprises multiple microphones configured to provide a substantially continuous noise signal to a noise spectrum estimation function of the noise reduction function to provide a substantially continuous estimate of noise. The noise estimate is used to adjust the filter co-efficients of the Wiener Filter thereby removing noise from the noisy speech.

Method of the Invention:

A method for speech recognition in a speech communication or computing device is described. The method comprises the steps of receiving noisy speech uttered by a speaker; filtering the noisy speech using a Wiener Filter to remove noise from the noisy speech; and recognising speech uttered by the speaker from the filtered noisy speech. The method further comprises the step of estimating a noise component of the noisy speech uttered by the speaker in a substantially continuous manner. The estimated noise is used in a substantially continuous manner to adjust filter co-efficients of the Wiener Filter, thereby removing noise from the noisy speech on a substantially continuous basis.

It will be understood that the improved speech communication unit incorporating the array microphone and noise estimation mechanism, as described above, tends to provide at least one or more of the following advantages:

(i) By using the noise estimate from the microphone array, the filter coefficients can be updated substantially continuously, for example each speech frame, thereby tracking the noise more closely than in known techniques. As the noise within a speech signal is tracked more closely, it can therefore be removed more effectively.

(ii) Overcomes the restriction of the noise being spatially diffuse, which applies to the sub-band Wiener filtering technique.

(iii) Allows continuous noise estimation to be used in conjunction with Wiener filtering rather than spectral subtraction.

Whilst specific, and preferred, implementations of the present invention are described above, it is clear that one skilled in the art could readily apply variations and modifications of such inventive concepts.

Thus, an improved speech communication unit has been described wherein the abovementioned disadvantages associated with prior art speech communication units have been substantially alleviated.

1. A speech communication or computing device (100) comprising:
at least one speech input device for receiving noisy speech uttered by a speaker; and
a speech processing function (130), operably coupled to the speech input device, having a voice recognition function (140) for recognising speech uttered by the speaker, wherein the voice recognition function (140) comprises:
a noise reduction function (235), having a Wiener Filter (335) with adjustable filter coefficients;
wherein the speech communication or computing device (100) is characterised in that:
the at least one speech input device comprises multiple microphones (142, 144) configured to provide a substantially continuous noise signal; and
the noise reduction function (235) comprises a noise spectrum estimation function (325) to provide a substantially continuous estimate of noise to adjust said filter coefficients of said Wiener Filter (335), thereby removing noise from said noisy speech.

2. The speech communication or computing device (100) according to claim 1, the speech communication or computing device (100) further characterised by said multiple microphones comprising at least one beamforming microphone array configured to provide a null on the speaker (405) to provide a substantially continuous noise signal.

3. The speech communication or computing device (100) according to claim 1, the speech communication or computing device (100) further characterised by a noisy speech spectrum estimation function (320), operationally distinct from said noise spectrum estimation function (325), such that said spectrum estimates for said noisy speech and said noise are performed substantially independently.

4. The speech communication or computing device (100) of claim 1, wherein said noise spectrum estimation function (325) provides a substantially continuous estimate of noise that updates said Wiener Filter coefficients substantially every speech frame.

5. The speech communication or computing device (100) according to claim 4, wherein the at least one microphone array is configured to provide both said noisy speech signal, for example via an output from a microphone from one or said multiple microphones, and said noise signal, for example via a microphone array output.

6. The speech communication or computing device (100) of claim 1, wherein said noise estimate is used to calculate coefficients of a Wiener Filter.

7. The speech communication or computing device (100) of claim 1, wherein the speech communication or computing device (100) is configured for operation as a distributed speech recognition device.

8. The speech communication or computing device (100) of claim 1, wherein the noise estimate is used to calculate coefficients of a Wiener Filter in accordance with the ETSI Advanced Front End distributed speech recognition Wiener Filter.

9. A method for speech recognition (600) in a speech communication or computing device (100) the method comprising the steps of:
receiving noisy speech (605) uttered by a speaker;
filtering (610) said noisy speech using a Wiener Filter to remove noise from said noisy speech; and
recognising speech (625) uttered by the speaker from said filtered noisy speech;
wherein the method is characterised by the steps of:
estimating (615) a noise component of said noisy speech uttered by said speaker in a substantially continuous manner from multiple microphones (142, 144) configured to provide a substantially continuous noise signal; and
using said estimated noise (620) in a substantially continuous manner to adjust filter coefficients of said Wiener Filter, thereby removing noise from said noisy speech on a substantially continuous basis.

10. (canceled)
